(19) United States
(12) Patent Application Publication
(10) Pub. No.: US 2014/0089779 A1
(43) Pub. Date: Mar. 27, 2014

(54) Electronic Book Generation Method of Composite Layer and Hypertext Markup Language and Reading Program

(71) Applicant: CHIDOPI CO., LTD., Taipei City (TW)

(72) Inventors: Yenting Lai, Taipei City (TW); Daniel Hsu, Hsinchu County (TW)

(73) Assignee: CHIDOPI CO., LTD., Taipei City (TW)

(21) Appl. No.: 13/627,019

(22) Filed: Sep. 26, 2012

(51) Int. Cl. G06F 17/00

(52) U.S. Cl. 715/234

(57) ABSTRACT

An electronic book generation method of a composite layer and a hypertext markup language includes the steps of (a) judging whether a trigger event which is predetermined to be input is existed or not; (b) acquiring a predetermined file of a layer or a hypertext markup language in accordance with a comparison table when the trigger event which is predetermined to be input is happened; and (c) acquiring a container corresponding to a format of the predetermined file so as to load the predetermined file in the container and add with a page.

### BACKGROUND OF THE INVENTION

1. Field of the Invention

The invention relates to an electronic book generation method and a reading program, in particular relates to an electronic book generation method of a composite layer and a hypertext markup language and a reading program.

2. Description of the Related Art

File formats such as TXT, DOC, HTML, CHM or PDF are commonly seen in present electronic books. In reading state, a user can utilize reading programs installed in Microsoft operation system of an electronic book reader to open the files with TXT, DOC, HTML and CHM formats, or can utilize a reading program published by Adobe Reader to open the files with PDF format.

However, the reading programs of the present electronic book readers is generally only supported for opening one single format file, i.e., files with two or more different formats cannot be supportively opened simultaneously. Therefore, the present electronic books cannot have diversified visual effects on pages to be displayed.

### BRIEF SUMMARY OF THE INVENTION

In view of this, the invention provides an electronic book generation method of a composite layer and a hypertext markup language and a reading program.

Accordingly, an electronic book generation method of a composite layer and a hypertext markup language of the invention includes the steps of: (a) judging whether a trigger event which is predetermined to be input is existed or not; (b) acquiring a predetermined file of a layer or a hypertext markup language in accordance with a comparison table when the trigger event which is predetermined to be input is happened; and (c) acquiring a container corresponding to a format of the predetermined file so as to load the predetermined file in the container and add with a page.

Preferably, the electronic book generation method judges whether a trigger event representing a page flip is existed or not, acquires the predetermined file of the layer or the hypertext markup language in accordance with the comparison table when the trigger event representing the page flip is happened, and acquires the container corresponding to the format of the predetermined file so as to load the predetermined file in the container and add with a page representing a next page.

Preferably, the electronic book generation method further includes the step of: dividing the page into a plurality of subregions which are respectively allotted a location parameter when judging that the page is loaded with a layer file, and presenting a special effect connected to the location parameter of a selected subregion when any of the subregions to be detected is selected.

Preferably, the electronic book generation method further includes the step of: executing element operations in accordance with any of elements of the page to be selected or presenting media effect by calling a media object, when judging that the page is loaded with a hypertext markup language file.

The electronic book reading program of the invention includes a judgment, a lookup table unit and a page unit. The judgment unit is utilized to judge whether a trigger event which is predetermined to be input is existed or not. The lookup table unit is utilized to acquire a predetermined file of a layer or a hypertext markup language in accordance with a comparison table when the trigger event which is predetermined to be input is happened. The page unit is utilized to acquire a container corresponding to a format of the predetermined file so as to load the predetermined file in the container and add with a page.

Preferably, the judgment unit of the electronic book reading program judges whether a trigger event representing a page flip is existed or not, the lookup table unit is provided for acquiring the predetermined file of the layer or the hypertext markup language in accordance with the comparison table when the trigger event representing the page flip is happened, and the page unit acquires the container corresponding to the format of the predetermined file so as to load the predetermined file in the container and add with a page representing a next page.

Preferably, the electronic book reading program further includes a layer unit, wherein the layer unit is utilized to divide the page into a plurality of subregions which are respectively allotted a location parameter when the page is loaded with a layer file and to present a special effect connected to the location parameter of a selected subregion when any of the subregions to be detected is selected.

Preferably, the electronic book reading program further includes a hypertext markup language unit, wherein the hypertext markup language unit is utilized to execute element operations in accordance with any of elements of the page to be selected or to present media effect by calling a media object, when the page is loaded with a hypertext markup language file.

With the efficacy of the electronic book generation method of the composite layer and the hypertext markup language and the electronic book reading program of the invention, the files with two or more different formats can be supportively opened, thereby overcoming the insufficiency of the reading programs in the present electronic book readers that are generally supported for opening one single format file. Moreover, the invention provides the page of the electronic book with diversified visual effect.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a system block diagram illustrating that a reading program of a preferred embodiment of the invention is installed in an electronic book reader;

FIGS. 2A and 2B are a flow chart illustrating a preferred embodiment of an electronic book generation method of a composite layer and a hypertext markup language; and

FIG. 3 is a schematic view illustrating a page effect presented by a reading program which is executed by an electronic book reader.

### DETAILED DESCRIPTION OF THE INVENTION

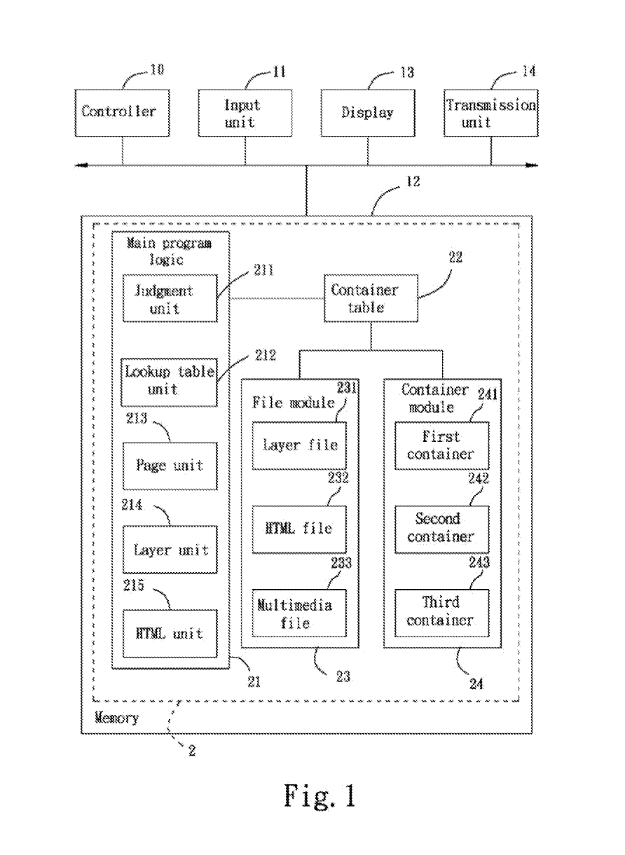

Referring to FIG. 1, in a preferred embodiment of the invention, an electronic book reader 100 includes a controller 10, an input unit 11, a memory 12, a display 13 and a transmission unit 14. An electronic book reading program 2 is installed in the memory 12 of the electronic book reader 100.

The controller 10 is a central processor to be responsible for coordinating and controlling the operations of each of the components. The input unit 11 is a touch pad, so that a user can generate a trigger event to inform the controller 10 to correspondingly execute a treatment process in a touch input manner. When the controller 10 receives the trigger event, the display 13 controls the displayed pages of the electronic book to perform such as page flip operations. The transmission unit 14 is a network interface provided for downloading related files or programs from communication networks such as 3G (third generation mobile communication networks).

The electronic book reading program 2 includes a main program logic 21, a comparison table 22, a file module 23 and a container module 24.

The main program logic 21 includes a judgment unit 211, a lookup table unit 212, a page unit 213, a layer unit 214 and a hypertext markup language unit 215. The comparison table 22 is utilized to record connections between each page and the files. The file module 23 includes at least one layer file 231, at least one hypertext markup language (HTML) file 232 and at least one multimedia file 233. In this embodiment, the layer file 231 is a PNG (portable network graphic) file, and the multimedia file 233 is a MP4 (motion picture expert group) file. The container module 24 includes a first container 241 for browsing of the layer file 231, a second container 242 for browsing of the hypertext markup language file 232, and a third container 243 for browsing of the multimedia file 233.

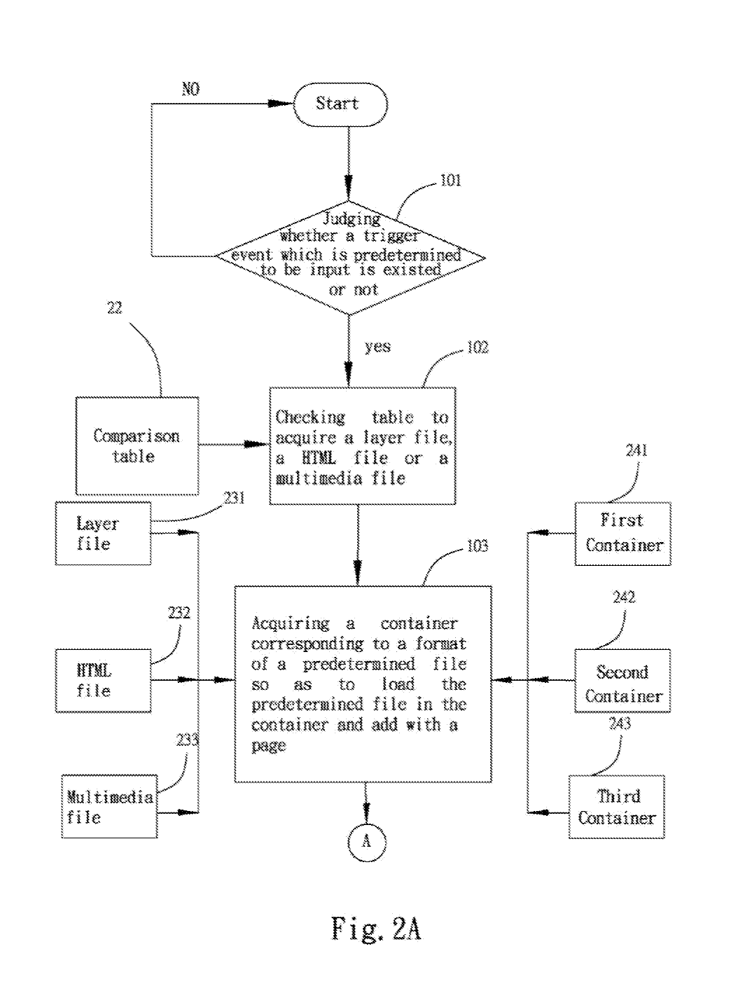

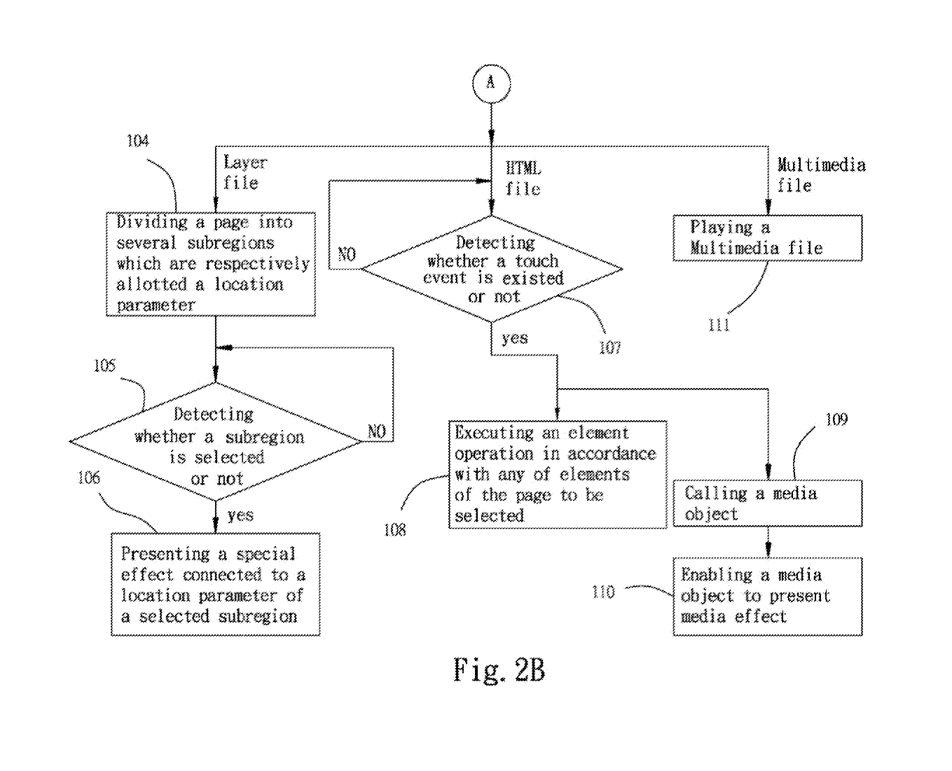

Referring to FIGS. 1, 2A and 2B, the electronic book generation method of the composite layer and the hypertext markup language of the preferred embodiment of the invention includes the following steps 101-111.

In the step 101, the judgment unit 211 judges whether a trigger event which is predetermined to be input is existed or not. For example, when the judgment unit 211 judges that a trigger event representing a page flip is existed, the step 102 is automatically executed.

In the step 102, the lookup table unit 212 acquires a predetermined file (e.g., the layer file 231, the hypertext markup language file 232 or the multimedia file 233) of a layer or a hypertext markup language in accordance with the comparison table 22. Preferably, when the trigger event which is predetermined to be input is happened, the lookup table unit 212 acquires the layer file 231, the hypertext markup language file 232 or the multimedia file 233 in accordance with the comparison table 22.

In the step 103, the page unit 213 acquires a container corresponding to a format of the predetermined file so as to load the predetermined file in the container and add with a page. Preferably, a container, which is acquired by the page unit 213 and corresponding to a format of the predetermined file, can be the first container 241 (e.g., an image viewer) capable of opening the layer file 231, the second container 242 (e.g., a HTML viewer) capable of opening the hypertext markup language file 232, or the third container 243 (a video viewer) capable of opening the multimedia file 233. After that, the layer file 231 is loaded in the first container 241 and a page representing a next page is added therein, the hypertext markup language file 232 is loaded in the second container 242 and a page representing a next page is added therein, or the multimedia file 233 is loaded in the third container 243 and a page representing a next page is added therein.

Then, if the page is loaded with the multimedia file 233, the step 111 of playing a multimedia files is directly executed. If the page is loaded with the layer file 231, the layer unit 214 executes steps 104, 105 and 106. If the page is loaded with the hypertext markup language file 232, the hypertext markup language unit 215 executes steps 107, 108, 109 and 110. The steps 104, 105, 106, 107, 108, 109 and 110 are described as follows.

In the step 104, the page is divided into a plurality of subregions which are respectively allotted a location parameter. For example, the page is divided into different subregions by grids in accordance with a tabulation, in which each of the subregions is provided with the location parameter representing an absolute coordinate (X, Y), and a special effect connected to the location parameter of at least one subregion is configured in the tabulation. In the step 105, a detection of whether a subregion is selected or not is executed. If the subregion is selected, the step 106 is executed. In the step 106, when any of the subregions to be detected is selected, a special effect connected to the location parameter of the selected subregion is presented.

In the step 107, a detection of whether a touch event is existed or not is executed. If a touch event is existed, a process is executed in accordance with a corresponding event of the touch event, i.e., the step 108 is executed if the touch event is an element event, or the step 109 or 110 is executed if the touch event is a media event. In the step 108, an element operation (e.g., HTML DIV Event) is executed in accordance with any of elements of the page to be selected, such as clicking one text for next page, clicking one figure for next figure, or clicking one film for direct play. In the step 109, a process of calling a media object is executed. In the step 110, a process of enabling the media object to present media effect is executed, such as calling an apple program (e.g., call in App Media Object) of iPad.

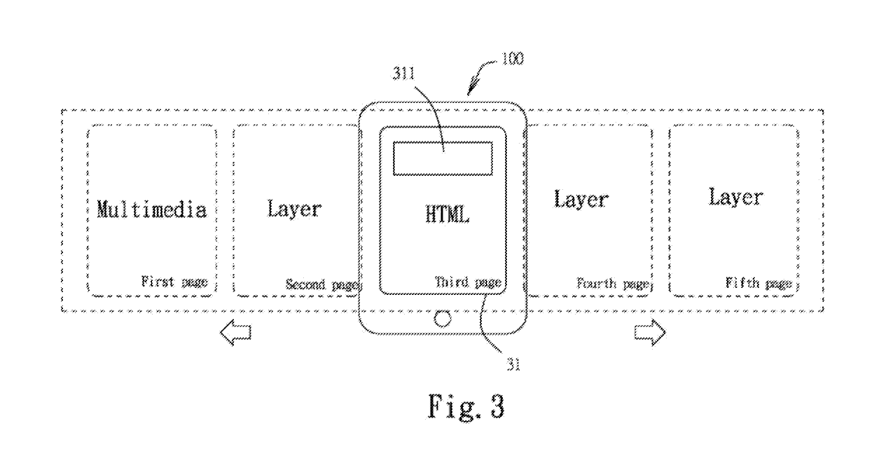

Referring to FIGS. 1 and 3, the comparison table 22 is presented as Table A.

TABLE A

| | | Second | | Fourth | |
|---|---|---|---|---|---|
| | First page | page | Third page | page | Fifth page |
| File | Multimedia | Layer file | HTML file | Layer file | Layer file |
| format | file | | | | |

A drag region 311 is configured on a page 31 which is presented by the electronic book reading program 2 executed by the electronic book reader 100. When the drag region 311 is triggered by the user, i.e., the trigger event representing the page flip is happened, the electronic book reading program 2 displays data on the page 31 in accordance with the files corresponding to previous and next pages.

In an additional remark, the electronic book reader 100 of the invention can be an iPad, a hand-held device or a tablet personal computer (PC). However, it is to be understood by those who skilled in this art that the invention is not limited to the above disclosed devices, but, on the contrary, is intended to cover any electronic devices capable of presenting the edited effect as the invention within the spirit and scope of the appended claims of the invention. Besides the reading program, no matter what products had been developed by any predetermined program logics, program syntaxes or development kits, the products that have applied with similar operation logic as the invention are also includes within the spirit and scope of the appended claims of the invention, not limited to the disclosed embodiments.

In conclusion, with the efficacy of the electronic book generation method of the composite layer and the hypertext markup language and the electronic book reading program 2 of the invention, the files with two or more different formats, including the layer file 231, the HTML file 232 and the multimedia file 233, can be supportively opened, thereby overcoming the insufficiency of the reading programs in the present electronic book readers that are generally supported for opening one single format file. Moreover, the invention provides the page 31 of the electronic book with diversified visual effects. Accordingly, the purpose of the invention can be surely attained.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An electronic book generation method of a composite layer and a hypertext markup language, comprising the steps of:
(a) judging whether a trigger event which is predetermined to be input is existed or not;
(b) acquiring a predetermined file of a layer or a hypertext markup language in accordance with a comparison table when the trigger event which is predetermined to be input is happened; and
(c) acquiring a container corresponding to a format of the predetermined file so as to load the predetermined file in the container and add with a page.

2. The electronic book generation method of the composite layer and the hypertext markup language as claimed in claim 1, wherein the step (a) judges whether a trigger event representing a page flip is existed or not, the step (b) acquires the predetermined file of the layer or the hypertext markup language in accordance with the comparison table when the trigger event representing the page flip is happened, and the step (c) acquires the container corresponding to the format of the predetermined file so as to load the predetermined file in the container and add with a page representing a next page.

3. The electronic book generation method of the composite layer and the hypertext markup language as claimed in claim 2 further comprising the step of:
dividing the page into a plurality of subregions which are respectively allotted a location parameter when the page is loaded with a layer file, and presenting a special effect connected to the location parameter of a selected subregion when any of the subregions to be detected is selected.

4. The electronic book generation method of the composite layer and the hypertext markup language as claimed in claim 2 further comprising the step of:
executing element operations in accordance with any of elements of the page to be selected or presenting media effect by calling a media object, when the page is loaded with a hypertext markup language file.

5. An electronic book reading program, comprising:
a judgment unit configured to judge whether a trigger event which is predetermined to be input is existed or not;
a lookup table unit configured to acquire a predetermined file of a layer or a hypertext markup language in accordance with a comparison table when the trigger event which is predetermined to be input is happened; and
a page unit configured to acquire a container corresponding to a format of the predetermined file so as to load the predetermined file in the container and add with a page.

6. The electronic book reading program as claimed in claim 5, wherein the judgment unit judges whether a trigger event representing a page flip is existed or not, the lookup table unit is provided for acquiring the predetermined file of the layer or the hypertext markup language in accordance with the comparison table when the trigger event representing the page flip is happened, and the page unit acquires the container corresponding to the format of the predetermined file so as to load the predetermined file in the container and add with a page representing a next page.

7. The electronic book reading program as claimed in claim 6 further comprising a layer unit, wherein the layer unit is configured to divide the page into a plurality of subregions which are respectively allotted a location parameter when the page is loaded with a layer file and to present a special effect connected to the location parameter of a selected subregion when any of the subregions to be detected is selected.

8. The electronic book reading program as claimed in claim 6 further comprising a hypertext markup language unit, wherein the hypertext markup language unit is configured to execute element operations in accordance with any of elements of the page to be selected or to present media effect by calling a media object, when the page is loaded with a hypertext markup language file.
